(19) United States
(12) Patent Application Publication
(10) Pub. No.: US 2011/0084528 A1
(43) Pub. Date: Apr. 14, 2011

(54) Delordosation device

(75) Inventor: Klaus Gierse, Radevormwald (DE)

(73) Assignee: In-Tra-Tec GmbH

(21) Appl. No.: 12/925,046

(22) Filed: Oct. 13, 2010

(30) Foreign Application Priority Data
Oct. 13, 2009 (DE) 20 2009 013 889.5
Apr. 7, 2010 (DE) 10 2010 014 122.4
Jun. 1, 2010 (DE) 10 2010 022 386.7

(51) Int. Cl. A61G 15/02

(52) U.S. Cl. 297/313

(57) ABSTRACT

The invention relates to a delordosation device for users of a rehabilitation appliance, in particular for the verticalization of a sit/stand exercise machine or a wheel chair with a seating area and support aids for a user, the seating area supported in a swiveling manner swiveling for verticalization. To avoid hyperlordosis while patients with a restricted mobility are being straightened up in rehabilitation measures or a verticalization in a sit/stand exercise machine 1 or wheel chair, it is provided that the seating area is supported in a swiveling manner, and at least a portion of the seating area is mounted in a movable manner. Thus, a pelvis rotation can be initiated during verticalization, whereby hyperlordosis is avoided.

### RELATED APPLICATIONS

This patent application claims priority from and incorporates by reference German utility model application DE 20 2009 013 889.5, filed on Oct. 13, 2009, German patent application DE 10 2010 014 122.4, filed on Apr. 7, 2010 and German patent application DE 10 2010 022 386.7, filed on Jun. 1, 2010.

### FIELD OF THE INVENTION

The invention relates to a delordosation device for users of a rehabilitation appliance, in particular for the verticalization of a sit/stand exercise machine or a wheel chair, having a seating area and support aids for the user, the seating area being mounted, so that it swivels for verticalization.

### BACKGROUND OF THE INVENTION

Delordosation devices are required for various purposes, for example in sit/stand exercise machines or wheel chairs when a verticalization function exists. This is a system that permits a user with restricted mobility to be transferred from a seated position to a standing position. Typical restricted mobility of users of such a sit/stand exercise machine or a wheel chair can originate from any conceivable forms of diseases or disabilities. These are, for example, spasticities, paraplegia, apallic syndrome, weakness or failure of the muscular system due to neurological diseases (MS; ALS; hemiplegia), as well as disability patterns with distinctive contractures which are due to a considerable shortening of the muscles and ligaments. With the aid of a sit/stand exercise machine, for example a therapeutic measure can be performed. To this end, sit/stand exercise machines, but also wheel chairs, that comprise a seating area on which the user can sit and which can be additionally fixated by suited support aids are known. By swiveling the seating area, it is achieved here that the user can be transferred to a standing position to at least partially remove the restricted mobility or to give therapy to the patients by therapeutic measures.

Verticalization devices are known in wheel chairs, for example from the European Patent EP 0 815 822 B1. This wheel chair permits to bring the wheel chair user into a nearly vertical position and to make him nearly adopt the posture of a standing person. Especially for wheel chair users with a restricted or non-restricted musculoskeletal system of the upper portion of the body, or for all persons who cannot stand, it is extremely helpful if the posture adopted by the verticalization device would correspond to a standing position of a person not restricted in his/her mobility. For this, it is necessary to support the function of the skeleton such that it can adopt its maximal support and standing function corresponding to its possibly restricted ability. Thus, a problem repeatedly occurs in that full-range hip extension, this means a hip extension corresponding to the anatomically possible degree of motion, can often not be achieved by the musculoskeletal system of the wheel chair user. This is in particular true in case of a spasticity of the hip flexor or a poor posture of the pelvis. Already with a hip flexor contracture caused by sitting permanently, a restricted hip mobility can be caused or with persons suffering from diplegia who have a restricted muscle function, full-range hip extension can be hindered and hyperlordosis can arise from this.

Sit/stand exercise machines are employed as therapeutic measures in clinics and therapy institutions to motivate the patients with restricted mobility to actively take part in life and avoid secondary diseases caused by sitting or lying for a relatively long time. The sit/stand exercise machines are essentially used to protect the patient from further damages to the vertebral column, while neurological patients can learn to stand alone again with the aid of the sit/stand exercise machine. For this, it is possible not to only learn the functions of standing again with the aid of a sit/stand exercise machine, but moreover to sufficiently utilize the freedom gained. Sit/stand exercise machines are therefore employed in the therapeutic field in hospitals, in the private field for self-therapy, or in the integrative field, and they usually not only serve for one patient, but can be time and again adapted to various patients of different heights if need be.

From the prior art, seating areas for wheel chairs and sit/stand exercise machines with swiveling mechanisms are known. However, in such an embodiment, the pelvis is only pushed forward. The pelvis tilted forward as a consequence causes a hyperlordosation (extreme S-shaped bending, also referred to as hollow back) of the vertebral column during the straightening up. A secondary disease of hyperlordosis is an extreme compression in the facet articulations of the lumbar spine resulting in backaches. In the long term, hypermobilities and instabilities can occur in these back articulations with possible nerve constrictions or incarcerations. The ultimate goal of verticalization must accordingly be a physiologically favorable spine support.

### BRIEF SUMMARY OF THE INVENTION

It is an object of the present invention to provide an improved delordosation device which permits the users to perform verticalization without any disadvantageous consequences for the musculoskeletal system.

For achieving the object, the invention provides for the seating area to be swiveling and at least a portion of the seating area to be movably mounted. Further advantageous embodiments of the invention can be taken from the following taken alone or in any suitable combination:
the seating area is configured in one piece and the entire seating area is supported in a movable manner;
the seating area is divided at least in two pieces with a first seating area portion supported in a swiveling manner and a second seating area portion that swivels together with the first seating area portion and the second seating area portion is movable with respect to the first seating area portion;
a movement of the seating area or a portion of the seating area is provided with delay, or the swiveling and movement of the seating area or a portion of the seating area is provided in a synchronized manner;
the seating area is configured to be moved from a horizontal position to a nearly vertical position;
the seating area is divided at least into two pieces and there is a dividing line transverse to the seated position, or the first seating area portion is configured U-shaped and comprises a front seating area for guiding a user's upper legs and two lateral seating areas for stabilizing the seated position, and the second seating area portion is configured as a central seating area which is supported in a movable manner between the two lateral seating areas of the first seating area portion;
the second seating area portion can move 2 to 12 cm relative to the first seating area portion;
the seating area is supported through frame elements or structural portions, and the at least a portion of the seating area supported in a movable manner is
mounted on a slide rail which is fixed to a frame element or a structural portion;
the at least a portion of the seating area supported in a movable manner is movable manually or electromotively, for example via a spindle drive or a hydraulic drive;
the at least a portion of the seating area supported in a movable manner is pushed to a position remote from a non-movable seating area portion through a gas pressure spring which is supported at the frame element or the structural portion;
a belt strap can be attached at a frame element or a structural portion on the one side and at the at least a portion of the seating area supported in a movable manner on another side, the movement of the seating area portion against the force of the gas pressure spring is limited, whereby the at least a portion of the seating area supported in a movable manner is pulled towards the non-movable seating area portion during the verticalization of the seating area;
the at least a portion of the seating area supported in a movable manner comprises guide rollers which are movable along a curved path during a verticalization of the seating area against the force of the gas pressure spring towards a non-movable seating area portion;
the movement of a central seating area portion can be adjusted through a deflection or shortening of the belt strap;
delordosation can be deactivated through the at least a portion of the seating area supported in a movable manner; and
the seating area can be used in stationary sit/stand exercise machines, mobile sit/stand exercise machines, manual wheel chairs with stand function, electric wheel chairs with stand function, seat systems, stand systems and positioning systems for disabled persons.

The delordosation system according to the invention works with an additional movement directly acting on the shortened musculature, a pelvis rotation. The direct consequence of a pelvis rotation is a straightening up the pelvis by a force rotating the pelvis and causes immediate delordosation (extension) of the vertebral column and thus a relief of the intervertebral disks. Up to now, these effects affects could be exclusively performed during a manual therapy which physiotherapeutically accompanies the stand training in a sit/stand exercise machine. The delordosating seating system according to the invention simulates the therapeutic course of movement by moving the seating area during verticalization. The stretching pressure developed in a seat padding here permits to pull the rear pelvis downward over the central seating area. The introduced force then achieves a straightening up of the pelvis via the hip joints with a considerably improved stretching effect affect on the musculature of the lower extremities. The pelvis is straightened up in a rotary motion.

In a first embodiment variant the seating area is configured in one piece and the complete seating area is movably mounted in addition. The seating area can thus be lifted at the back while initiating the verticalization to achieve the desired standing position of the patient. By a movable support which can be, for example, articulated manually, but also with electromotive support, a rotary motion is exerted on the pelvis which permits immediate delordosation (extension) of the vertebral column. By swiveling and moving the seating area, the rotary motion is thus causally imposed on the pelvis as straightening up is progressing. By this, verticalization is facilitated for the patient and does not result in hyperlordosis by the rotary motion of the pelvis. This particular advantage is already achieved by a first simple embodiment with a single-pieced seating area.

In a particular embodiment of the invention, the seating area is configured at least in two pieces, and a first seating area portion is mounted in a swiveling manner, while a second seating area portion is swiveled together with the first seating area portion and movably supported with respect to the first seating area portion.

Through the two-portion seating area with a first seating area portion which is swiveling, and a second seating area portion which is supported swiveling and movable, it is possible to ensure sufficient support and simultaneously support the achievement of verticalization through the seating area by an enforced pelvis rotation, and to achieve a delordosation (extension) of the vertebral column and thus the relief of the intervertebral disks. By this, it is facilitated for the user or patients to stand up with support, for example in a sit/stand exercise machine or a wheel chair with verticalization function. For example in case of a strong muscular tension (flexion spasticities) or shortenings of the muscular system, in particular in the lower extremities, or a poor posture of the pelvis to the front, the seating area according to the invention is extremely helpful for straightening up.

To perform verticalization, it is provided that the seating area can be transferred from a horizontal position to a nearly vertical position, so that, during the movement, a defined seat depth is provided for the pelvis of the user or patient, respectively, and is supported during the movement.

For this reason, it is particularly advantageous for the seating area to be configured divided into two portions, where the swiveling and moving of a portion of the seating area can be performed in a synchronized manner, or the movement can be preferably advantageously performed with some delay. The synchronized movement ensures that the desired pelvis rotation occurs at a certain point in time, where first swiveling is performed until the movement of the second seating area portion causes the initiation of the pelvis rotation. Synchronized swiveling and movement can also be timed, or the movement can be performed at different time-delayed speeds.

In one embodiment, it is provided for the seating area to be configured at least in two portions, where a dividing line can extend transversely with respect to the seat position. Thus, the seating area includes a front partial seating area and a rear partial seating area, the rear partial seating area being supported movable with respect to the front partial seating area. Thus, the advantages according to the invention are achieved with such an embodiment, where the movement of the rear partial seating area can be performed either manually, or possibly via a drive. Manual movement is helpful, for example, if physiotherapeutic treatment is employed, if full-range extension is not yet possible for a patient and delordosation is to be used, for example, for a straightening up by 50%.

In one particular embodiment, it is provided for the first seating area portion to have a U-shaped design and comprise a front seating region for guiding the upper legs, and two lateral seating areas for stabilizing the seated position, and the second seating area portion is configured as a central seating region which is mounted to be movable between the two lateral seating areas of the first seating area portion.

By embodying a first seating area portion, for example, in a U-shape, stabilization of the seated position is achieved, while the second movable seating area portion causes the desired pelvis rotation. The U-shaped enclosure of the inner central seating area portion is basically arranged here not to be movable to ensure, in the seated position, the correct adjustment of the seating depth with a plane, pressure-relieving support of the thighs and the ischiums (tubes). A good seated position is important because the user of the sit/stand exercise machine can interrupt his standing training with rest periods only in this manner. For example, in a sit/stand exercise machine, the seated position will be used essentially more often than the standing position. In the aforementioned embodiment, optimal pressure distribution in the region of the central seating area portion is for example achieved, and simultaneously a pelvis rotation is caused during verticalization.

For this, it is provided that the second seating area portion performs a relative movement of 2 to 12 cm, preferably advantageously 4 to 9 cm with respect to the first seating area portion. This relative movement between the two seating area portions is sufficient here to cause the desired pelvis rotation during straightening up. To avoid bruises, at least a small gap of 2.5 cm remains between the seating area portions during the movement.

In order to ensure sufficient stability of the seating area, the same is supported via frame elements or structural parts of the sit/stand exercise machine, or for example of a wheel chair, where the movable seating area portion is mounted on a slide rail which is fixed to a frame element or a structural part. Here, the slide rail is configured to be extremely flat and is located underneath the seating area, whereby a corresponding stability of the slide rail, jamming or bending in case of a corresponding load can be excluded. The movable seating area portion can be mounted here in the slide rail to be movable manually, electromotively, for example via a spindle drive or a hydraulic drive. A manual adjustment of the movable seating area portion represents the simplest embodiment, where a therapist can manually move the movable seating area portion while the patient is being straightened up, that means verticalized. In order to facilitate the movement of the movable seating area portion for the patient in self-therapy, an electromotive drive, for example a spindle drive, or a hydraulic drive can be provided, which performs the movement of the rear seating area portion either via manual control or a control means. Through a spindle drive or a hydraulic drive, it is here simultaneously ensured that the desired position of the movable seating area portion can be adjusted to the nearest millimeter. Here, it is further possible that with the initiation of the verticalization function of the sit/stand exercise machine or the wheel chair, the rear movable seating area portion performs the required movement for the pelvis rotation either with some delay or possibly synchronized with the swiveling of the front seating area portion.

As an alternative, it is possible that the movable seating area portion is pushed into a position that is remote with respect to the non-movable seating area portion by a gas pressure spring which is supported at the frame element or structural portion. That means that the gas pressure spring would hold the movable seating area portion always fixed in the direction of the backrest, however, to perform the required shifting motion, a belt strap is moreover provided which can be fixed on the one hand at the frame element or structural portion, and on the other hand at the movable seating area portion. The belt strap serves to pull the movable seating area portion towards the front seating area portion against the force of the gas pressure spring. By the length of the belt strap and the beginning verticalization, that means the swiveling of the complete seating area, a movement of the seating area is caused due to the mechanism employed, where the belt strap pulls the movable seating area portion to the front towards the fixed seating area portion. For this, it is alternatively possible for the movable seating area portion to include guide rollers which are pushed along a curved path in a verticalization of the seating area against the force of the gas pressure spring towards the non-movable seating area portion. By means of the guide rollers and the curved path, a likewise arched movement of the seating area is achieved, which in turn leads to the rear movable seating area portion moving towards the front fixed seating area portion against the force of the gas pressure spring.

If a belt strap is used for moving the rear seating area portion, the time of the movement of the rear seating area portion can be adjusted via a deflection of the belt strap or a shortening of the belt strap, where it is especially possible that by releasing the belt strap, the movable seating area portion remains in the rear position and thus delordosation can be deactivated. During the return from the standing position to the seated position, the gas pressure spring takes care herein that the movable seating area portion returns into its original position. It is thus ensured that, after his stand training, the user of the sit/stand exercise machine is sitting again in the position in which he has originally started his standing training. Thus, an exact positioning individually demanded by the doctor and therapist can be repeated as often as desired.

The present invention is suited for being subsequently integrated into already existing sit/stand exercise machines or wheel chairs. Normally, the seating area includes a fixed seating plate integrated in the sit/stand exercise machine or the wheel chair. The delordosation device according to the invention is subsequently integrated instead of the existing fixed seat plate, or it can be provided directly when a sit/stand exercise machine or wheel chair is constructed.

The described embodiments of the invention permit the use of manually as well as hydraulically or electromechanically driven verticalization systems. In particular, one embodiment variant is conceivable which provides the movement of the seating area electromotively or hydraulically by the user himself/herself, or which can be adjusted to his/her demands depending on the verticalization angle.

The basic structure of a typical sit/stand exercise machine includes a headrest, a backrest, a belly/breast pelotte, an armrest and the seating area as well as a lower leg pelotte and a footrest. For the user to be able to adopt the seated position, here, the belly and breast pelotte as well as the lower leg pelotte and the armrests are preferably configured to be swiveling. After the seated position has been reached, it is possible to adapt the belly pelotte, the breast pelotte and the lower leg pelotte to the height of the user. For the therapeutic exercises, the patient is transferred from a seated position to a standing position, where, according to the invention, this procedure is facilitated or even only permitted by a pelvis rotation. To this end, in the delordosation device according to the invention, the seating area is configured to be swiveling and partially movable, so that the pelvis of the user can perform a pelvis rotation.

### BRIEF DESCRIPTION OF THE DRAWINGS

The invention will be further illustrated below with reference to drawing figures, wherein:

FIG. 1 illustrates a sit/stand exercise machine with a horizontally oriented seating area in a perspective side view;

FIG. 2 illustrates the sit/stand exercise machine of FIG. 1 with a vertical orientation vertical orientation of the seating area in a perspective side view;

FIG. 3 illustrates the seating area of the sit/stand exercise machine in an enlarged detail;

FIG. 4 illustrates a diagram for illustrating the rotary movement of the pelvis; and

FIG. 5 illustrates a wheel chair with a seating area according to the invention in a perspective view.

### DETAILED DESCRIPTION

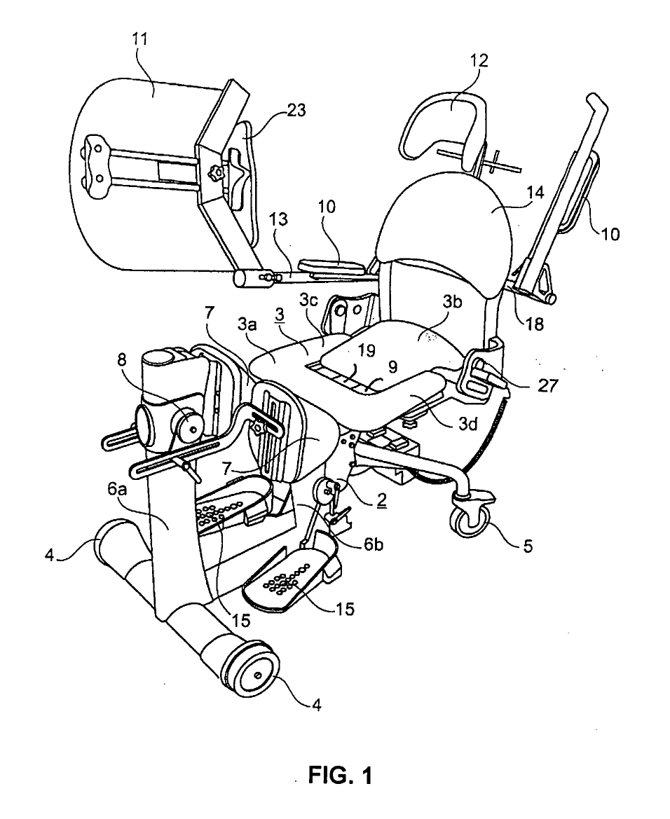

FIG. 1 illustrates a sit/stand exercise machine 1 in a nearly horizontal seated position in a perspective side view. The sit/stand exercise machine 1 includes a base frame 2 which is equipped with a seating area 3. The complete sit/stand exercise machine 1 rests on front casters 4 and rear casters 5. At the level of the front casters 4, a vertical structural portion 6a configured as a front portion is arranged which is provided for receiving the knee supports 7. The knee supports 7 can be individually adjusted through a swiveling device 8.

The seating area 3 is functionally supported by armrests 10 and by a therapy table 11 as well as a headrest 12. The therapy table 11 is configured swiveling laterally as well as backwards via corresponding mountings through a swivel arm 13 and a common swivel pin 18 of the armrests 10. A single armrest 10 can also be swiveled through the swivel pin 18 for shifting a patient backwards.

The seating area 3 is an important component of the verticalization function of the sit/stand exercise machine 1 in that the complete seating area 3 can be oriented vertically to thus shift the patient from a seated to a standing position. In the lower region, the patient is supported by the knee supports 7 and footrests 15, while the pelvis is supported by the seating area 3 which configured to swivel to a nearly vertical position. The patient is additionally supported by a backrest 14, where the patient can be additionally supported by a breast and belly pelotte 23.

In a simple embodiment, the seating area 3 can be configured in one piece, where the complete seating area is mounted to be movable, preferably by a slide rail. By swiveling and moving the seating area 3, the rotary motion is imposed on the pelvis caudally while the pelvis is increasingly straightened up, whereby the verticalization is facilitated for the patient and thus the rotary motion of the pelvis does not lead to an undesired hyperlordosis through the movement of the seating area 3. This particular advantage is already achieved by a first simple embodiment with a single-pieced seating area 3.

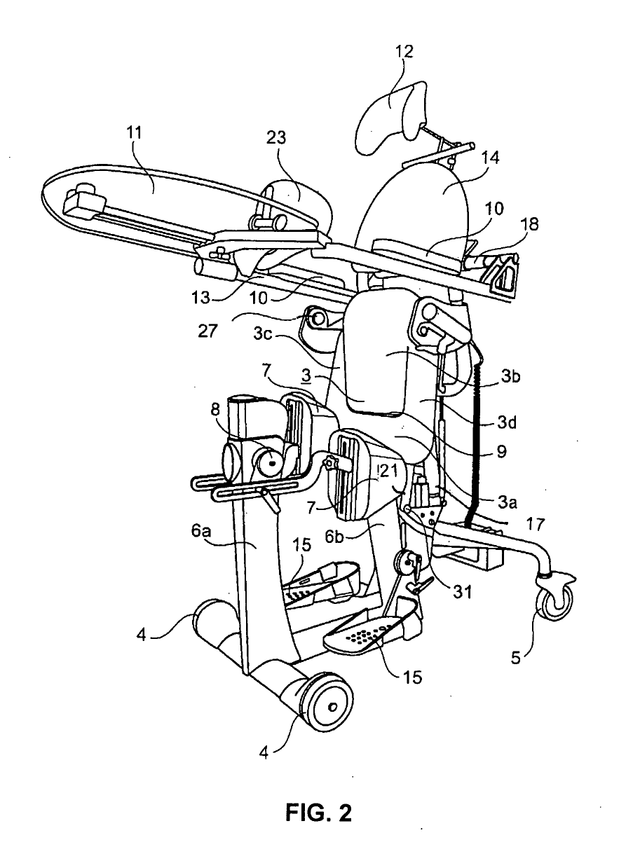

In FIG. 1, a two-portion seating area 3 is illustrated with a first fixed seating area portion 3 which is supported only to be swiveling, and a second movable seating area portion 3b which is supported to be swiveling together with the first seating portion 3a and movable with respect to it. Through this particular embodiment of the seating area 3, a further improved possibility of supporting an enforced pelvis rotation for achieving a verticalization through the seating area portions 3a, 3b is provided, wherein particular delordosation (extension) of the vertebral column and thus a relief of the intervertebral disks is achieved. For this reason, the seating area is divided into the seating area portions 3a, 3b, where the swiveling and movement of one portion of the seating area can be performed with some delay or optionally synchronously. Through the synchronized movement, it is ensured that the desired pelvis rotation occurs only at a certain point in time, where first a partial swiveling is performed until the movement of the second seating area portion 3b supports the initiation of the pelvis rotation. To perform the verticalization, it is provided that the seating area is transferred from a horizontal position to a nearly vertical position according to FIG. 2, so that the pelvis of the patient is supported during the movement and after the movement has terminated. Belly padding at the therapy table or a belly belt increases the pressure against the seating area portion 3b.

The first seating area portion 3a is configured in a U-shape to guide the lower legs, where two laterally fixed seating areas 3c, 3d are configured for stabilizing the seated position. Through the lateral seating regions 3c, 3d and the fixed seating area 3a, an optimal blood circulation in the thighs is achieved in the seated position. The second seating area portion 3b, however, is configured as central seating region which is mounted to be movable between the two lateral seating regions 3c, 3d of the first seating area portion 3a. By this, an optimal pressure distribution is achieved in the region of the central seating area portion 3b, where the second seating area portion 3b performs a relative movement with respect to the first seating area portion 3a of 2 to 12 cm, advantageously 4 to 9 cm. This small relative movement between the two seating area portions 3a, 3b is already sufficient to cause the desired pelvis rotation during straightening up. To avoid bruises, at least a small gap 9 remains between the seating area portions 3a, 3b.

The desired pelvis rotation is caused in the novel structure by the second movable seating area portion 3b. The U-shaped enclosure of the inner central seating area portion 3b is arranged not to be movable to ensure in the seated position the correct adjustment of the seating depth with a plane, pressure-relieving support of the thighs and the ischiums (tubes). For this reason, the second alternative represents an optimal solution, while the first illustrated alternative represents an inexpensive delordosation system.

The central seating area portion 3b is mounted on a slide rail 19 to permit the desired movement. Through a gas pressure spring 20, the seating area portion 3b is pushed into a position facing away from the first seating area portion 3a. By a belt strap 21 with adjustable length, this position can be adjusted to be limited. The belt strap 21 is connected on the one hand to the structural portion 6b of the sit/stand exercise machine 1, and on the other hand to the movable seating area portion 3b. Thus, during verticalization, the movable seating area portion 3b is pulled forward towards the first seating area portion 3a by the belt strap 21 due to the movement of the seating area by the used mechanism, whereby the pelvis rotation is initiated. The length of the belt strap 21 can be easily adjusted and thus permits a movement of the movable seating area portion 3b adjusted to the requirements of the patient. By deflecting the belt strap 21 according to the lifting pulley principle, the time of the movement of the seating area portion 3b can be changed in addition. If no delordosation for the patient is desired, delordosation can be deactivated by disengaging the belt strap 21 to be able to use the sit/stand exercise machine 1 exclusively in its original functionality for another patient. This is helpful, for example, in a physiotherapeutic treatment, if full-range extension is not yet possible for a patient and delordosation is to be used, for example for straightening by up of 50%.

To achieve a return of the seating area portion 3b to its original position, the gas pressure spring 20 is provided. This in particular ensures that the patient of the sit/stand exercise machine 1 returns to the original, seated position after his/her stand training. Thus, an exact positioning demanded by the doctor and therapist can be repeated as often as desired.

A movement of the seating area portion 3b can be alternatively performed electromotively or hydraulically. For the seating area portions 3a, 3b to be sufficiently held, the structural portion 6b is provided on which the seating area portions 3a, 3b are supported, where the central seating area portion 3a is preferably mounted on a slide rail 19 which is directly connected to the structural portion 6b or indirectly via further frame elements 25. Here, it is possible to use, as electromotive seat adjustment, a slide rail 19 with an integrated spindle drive, where the spindle motor is arranged in the slide rail 19 underneath the seating area 3.

The seating area 3 according to the invention is configured for subsequent assembly into already existing sit/stand exercise machines 1 or wheel chairs, or it can be provided directly during the first assembly.

FIG. 2 illustrates the sit/stand exercise machine 1 of FIG. 1 in a vertical position with a shifting of the seating area 3 into a vertical position. The base frame 2 is supported firmly on a base with its casters 4, 5, where a structural portion 6a is provided for fixing the knee supports 7, while a second structural portion 6b is used for mounting the seating area 3. In the rear region of the seating area 3, a swivel pin 27 is configured at which the backrest 14 is mounted in a swiveling manner. Thus, the backrest 14 can remain in a pre-adjusted position of the angle of inclination during the erection of the seating area 3, while the seating area 3 is lifted in the rear region. An armrest 10 each is laterally hinged at the backrest 14 through a swivel pin 18, where the depth of the armrest 10 can also be additionally adjusted manually. An armrest 10 is additionally provided with a therapy table 11 which can be laterally swiveled out of the portion of the patient through a swivel arm 13. Thus, the patient can enter the sit/stand exercise machine 1 supported by a therapist without any dislocations and obstacles.

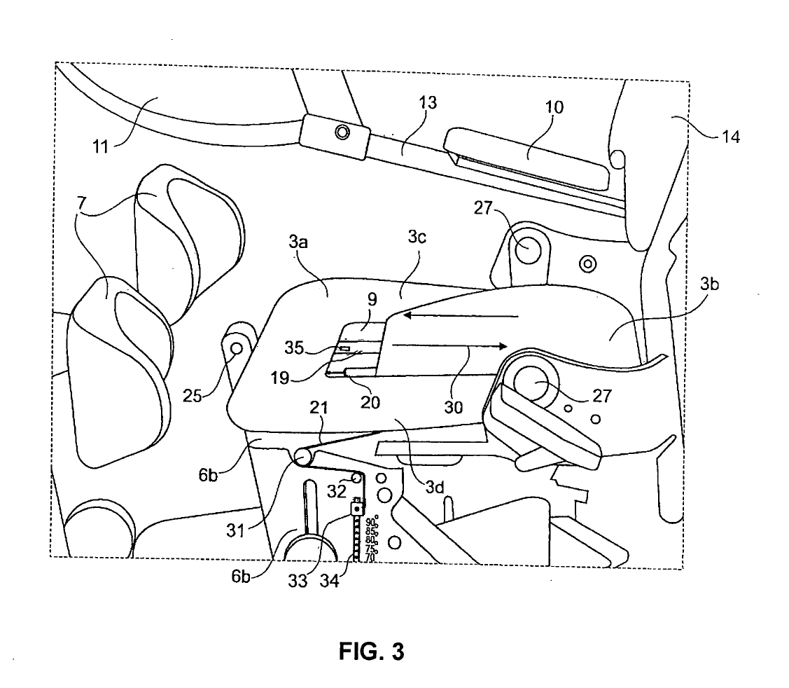

FIG. 3 illustrates the seating area 3 including the seating area portion 3a and 3b in an enlarged partial view. The arrows 30 indicate the direction of movement of the seating area portion 3b, i.e. the central seating area portion 3b moves between the lateral seating area portions 3c and 3d of the seating area portion 3a. During verticalization, first the seating area portion 3a, which is supported at the structural portion 6b via a hinge pin 25, is lifted in the rear portion, and at a later time, the seating area portion 3b is additionally moved forward, that means away from the backrest 14. Underneath the seating area portion 3a, a slide rail 19 can be seen which permits the movement of the second seating area portion 3b with respect to the first seating area portion 3a. Lifting of the seating area portions 3a, 3b is effected by a mechanism which swivels both seating area portions 3a, 3b with respect to the hinge pin 25, where possibly the forward movement of the second seating area portion 3b is effected with some delay by means of a belt strap 21. In this embodiment, the belt strap 21 is guided by a belt deflection 31, 32 to a shifting slide 33, which is adjustable using latches along a shifting track 34 with labeled angular degrees. The limit for adjusting the movable sitting area 3b is determined by the adjusted length of the belt strap 21, in order to personalize the modification to the individual patient. In addition, an end switch 35 determines the maximum adjustable length of the movable seating area 3b.

By adjusting the length of the belt strap 21 using the shifting slide 33 the delordosation device can be adjusted to finish delordosation before reaching the sitting up angle of the seating area from 90° down on. The end switch 35 forces the sitting up process to stop as soon as the movable seating area 3b is pulled up front entirely by the belt strap 21, thus the delordosation process is finished according to the prior set sitting up angle. This allows a slow extension of contraction and bending muscles, which can be set by the user himself or a third person. At the same time the angularly synchronized delordosation stops an over extension during standing training, for example, for children and mentally disabled persons. The movable seating area 3b is pulled back by a gas pressure string, which is placed in between fixed and movable seating areas 3a and 3b. As an alternative, it is possible to move the second seating area portion 3b towards the first seating area portion 3a by a slide rail with a spindle motor to effect the desired pelvis rotation in the verticalization of a patient.

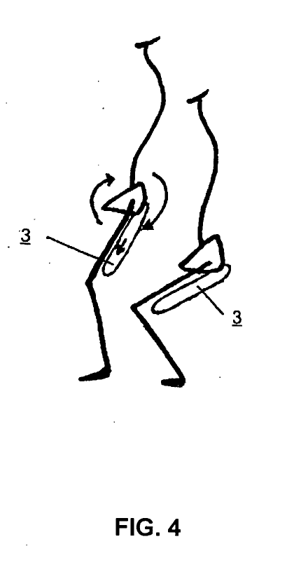

The principle of the pelvis rotation can be seen in FIG. 4, which shows a diagram in which the movement of the seating area 3 is illustrated again. The pelvis 32 of a patient rests on the seating area 3 and is normally blocked while the seating area 3 is swiveled, that means a rotation of the pelvis 32 is prevented, while in the solution according to the invention, a rotary movement is in addition exerted on the pelvis 32 by a swiveling and longitudinal movement of the rear seating area portion 3b, namely clockwise when the patient is looked at from the left side. This rotation is caused by a movement of the rear seating area portion 3b in the caudal direction and here prevents hyperlordosis.

The seating area 3 according to the invention can be employed here in sit/stand exercise machines 1 or other therapeutic rehabilitation appliances and in particular in wheel chairs with verticalization function.

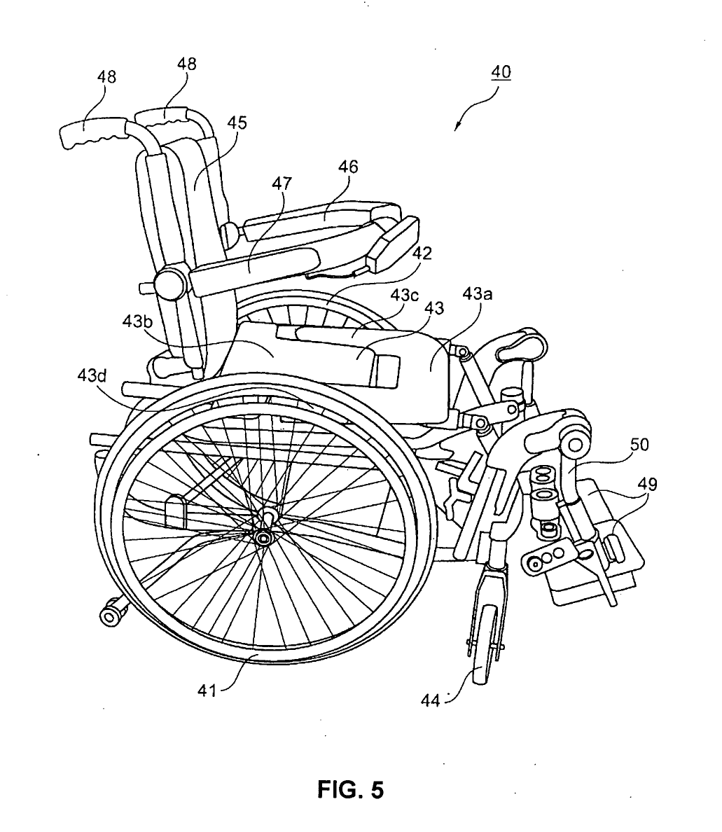

FIG. 5 illustrates a wheel chair 40 which principally has a standard design in a perspective view. This design includes two large casters 41, 42 underneath a seating area 43 as well as two small casters 44 to ensure the mobility of the wheel chair. The seating area 43 is followed by a backrest 45 that comprises lateral armrests 46, 47. Above the backrest 45, hand grips 48 are provided in addition, so that the wheel chair 40 can be possibly pushed by a third person. A footrest 49 is located in front of the small casters 44 which can be adjusted via guide rods 50 in the respective position. The illustrated wheel chair 40 further includes a verticalization function that means that the seating area and the backrest can be lifted, so that the seating area can be transferred to a nearly vertical position.

The seating area 43 used here is also divided into two pieces and includes a front fixed seating area portion 43a which comprises lateral fixed seating area portions 43c and 43d. The second movable seating area portion 43b is located between the two lateral seating area portions 43c and 43d, where the seating area portion 43a is, in one embodiment according to the invention, designed to be swiveling, and the seating area portion 43b can be swiveled together with the seating area portion 43a, but it can perform in addition a movement of the backrest 45 away towards the seating area portion 43a. Thus, the pelvis is rotated while it is supported in the already described manner when the wheel chair 40 is erected, so that the straightening up of the person sitting in the wheel chair is essentially facilitated.

### REFERENCE NUMERALS AND DESIGNATIONS

1 Sit/stand exercise machine

2 Base frame

3 Seating area

3a Fixed seating area

3b Movable seating area

3c Fixed seating area

3d Fixed seating area

4 Caster

5 Caster

6a Structural portion

6b Structural portion

7 Knee support

8 Swiveling device

9 Gap

10 Armrest

11 Therapy table

12 Headrest

13 Swivel arm

14 Backrest

15 Footrest

17 Linear drive

18 Hinge pin

19 Slide rail

20 Gas pressure spring

21 Belt strap

23 Belly and breast pelotte

25 Hinge pin

27 Swivel pin

30 Arrow

31 Belt deflection

32 Belt deflection

33 Shifting slide

34 Shifting track

35 End switch

40 Wheel chair

41 Caster

42 Caster

43 Seating area

43a Fixed seating area portion

43b Movable seating area portion

43c Fixed seating area portion

43d Fixed seating area portion

44 Caster

45 Backrest

46 Armrest

47 Armrest

48 Hand grip

49 Footrest

50 Guide rod

What is claimed is:

1. A delordosation device for a verticalization rehabilitation appliance, comprising:
a seating area supported in a swiveling manner for verticalization of a user with at least a portion of the seating area supported in a movable manner; and
support devices for the user.

2. The delordosation device according to claim 1, wherein the seating area is configured in one piece and the entire seating area is supported in a movable manner.

3. The delordosation device according to claim 1, wherein
the seating area is divided at least in two pieces with a first seating area portion supported in a swiveling manner and a second seating area portion that swivels together with the first seating area portion and the second seating area portion is movable with respect to the first seating area portion.

4. The delordosation device according to claim 1, wherein a movement of the seating area or a portion of the seating area is provided with delay, or the swiveling and movement of the seating area or a portion of the seating area is provided in a synchronized manner.

5. The delordosation device according to claim 1, wherein the seating area is configured to be moved from a horizontal position to a nearly vertical position.

6. The delordosation device according to claim 1, wherein the seating area is divided at least into two pieces and there is a dividing line transverse to the seated position, or the first seating area portion is configured U-shaped and comprises a front seating area for guiding a user's upper legs and two lateral seating areas for stabilizing the seated position, and the second seating area portion is configured as a central seating area which is supported in a movable manner between the two lateral seating areas of the first seating area portion.

7. The delordosation device according to claim 1, wherein the second seating area portion can move 2 to 12 cm relative to the first seating area portion.

8. The delordosation device according to claim 1, wherein the seating area is supported through frame elements or structural portions, and the at least a portion of the seating area supported in a movable manner is mounted on a slide rail which is fixed to a frame element or a structural portion.

9. The delordosation device according to claim 1, wherein the at least a portion of the seating area supported in a movable manner is movable manually or electromotively.

10. The delordosation device according to claim 1, wherein the at least a portion of the seating area supported in a movable manner is pushed to a position remote from a non-movable seating area portion through a gas pressure spring which is supported at the frame element or the structural portion.

11. The delordosation device according to claim 1, wherein a belt strap can be attached at a frame element or a structural portion on the one side and at the at least a portion of the seating area supported in a movable manner on another side, the movement of the seating area portion against the force of the gas pressure spring is limited, whereby the at least a portion of the seating area supported in a movable manner is pulled towards the non-movable seating area portion during the verticalization of the seating area.

12. The delordosation device according to claim 1, wherein the at least a portion of the seating area supported in a movable manner comprises guide rollers which are movable along a curved path during a verticalization of the seating area against the force of the gas pressure spring towards a non-movable seating area portion.

13. The delordosation device according to claim 1, wherein the movement of a central seating area portion can be adjusted through a deflection or shortening of the belt strap.

14. The delordosation device according to claim 1, wherein delordosation can be deactivated through the at least a portion of the seating area supported in a movable manner.

15. The delordosation device according to claim 1 one of the preceding claims, wherein the seating area can be used in stationary sit/stand exercise machines, mobile sit/stand exercise machines, manual wheel chairs with stand function, electric wheel chairs with stand function, seat systems, stand systems and positioning systems for disabled persons.

16. The delordosation device according to claim 1, wherein the at least a portion of the seating area supported in a movable manner and is movable electromotively via a spindle drive or a hydraulic drive.
